(19) United States
(12) Patent Application Publication
(10) Pub. No.: US 2025/0251326 A1
(43) Pub. Date: Aug. 7, 2025

(54) TEST SPECIMENS WITH PROPERTIES IDENTIFICATION

(71) Applicant: Product Innovation and Engineering, LLC, St. James, MO (US)

(72) Inventors: Sriram Praneeth ISANAKA, Rolla, MO (US); Fuewen LIOU, Rolla, MO (US)

(21) Appl. No.: 19/041,757

(22) Filed: Jan. 30, 2025

Related U.S. Application Data
(60) Provisional application No. 63/548,734, filed on Feb. 1, 2024.

(51) Int. Cl. G01N 3/02; B22F 10/28; B33Y 10/00; B33Y 80/00

(52) U.S. Cl. CPC G01N 3/02; B33Y 10/00; B33Y 80/00; B22F 10/28

(57) ABSTRACT

A test specimen has a marking on the test specimen that identifies properties of the test specimen. The marking is integral with the test specimen and more specifically is integral with the exterior surface of the test specimen. The marking is produced on the exterior surface of the test specimen as the test specimen is produced and cannot be easily removed from the test specimen.

### CROSS-REFERENCE TO RELATED APPLICATION

The present application claims the benefit and priority of U.S. Provisional Patent Application No. 63/548,734 filed Feb. 1, 2024. The entire disclosure of the above patent application is incorporated herein by reference.

### FIELD

The present disclosure generally relates to test specimens with properties identification.

### BACKGROUND

This section provides background information related to the present disclosure which is not necessarily prior art.

Material specimen testing is used in determining properties of the tested material, for example tensile strength, yield or breaking strength and maximum elongation, creep, fatigue, compressive testing and other measurements of material properties. Testing of a material specimen is performed for a variety of purposes, such as selecting a material for a particular application, predicting how the selected material will perform in the application, and predicting how the material will perform when subjected to normal use forces and extreme use forces.

A typical test specimen of a material has a standardized configuration often described as a “dumbbell” or “dog bone” configuration. The typical test specimen has a configuration of a cylindrical rod with a circular cross section, or a configuration of a flat strip with a rectangular cross section. The “dumbbell” configuration of the test specimen provides the test specimen with a narrow, gauge section at a center portion of the test specimen length and two large shoulder sections at opposite end portions of the test specimen length.

It is often desirable to label or mark a test specimen to provide information on or identify properties of the material of the test specimen. For example, it is often desirable to identify the material of the test specimen, manufacturing process of the test specimen, spatial location of the test specimen, the grain structure of the test specimen, an alloy composition of the test specimen, a density of the test specimen, etc.

It is difficult to identify properties of a test specimen by labeling the test specimen in a conventional manner. This is particularly true of a miniature test specimen where the exterior surface area of the miniature test specimen is significantly reduced and there is little area available for applying a marking. For example, test specimens can be labeled by applying written or printed markings on the exterior of the test specimen with paint, ink or other similar type of marking material. Test specimens can be labeled by attaching an identifying label to the exterior of the test specimen such as a self-adhesive label, a taped label, etc. This labelling typically does not take place immediately after the test specimens are produced, and therefore mistakes can occur due to the delay in the labelling. Additionally, test specimens are typically stored in a batch and can contact each other causing the printed markings labelling a test specimen to be obscured or the attached labels removed.

### DRAWINGS

The drawings described herein are for illustrative purposes only of selected embodiments and not all possible implementations, and are not intended to limit the scope of the present disclosure.

FIG. 1 is a perspective view of a test specimen according to an exemplary embodiment of this disclosure.

FIG. 2 is a perspective view of a test specimen according to another exemplary embodiment of this disclosure.

FIG. 3 is a side elevation view of the test specimen shown in FIG. 2.

FIG. 4 is a side elevation view of a laser powder bed fusion machine producing a test specimen according to an exemplary embodiment of this disclosure.

FIG. 5 is a plan view of the test specimen shown in FIG. 4.

Corresponding reference numerals may indicate corresponding (though not necessarily identical) features throughout the several views of the drawings.

### DETAILED DESCRIPTION

Example embodiments will now be described more fully with reference to the accompanying drawings.

As recognized herein, there is a need for a test specimen having an identification marking formed integrally on the exterior of the test specimen at the time the test specimen is produced to avoid mistakes, where the identification marking identifies properties of the material of the test specimen and the marking cannot easily be removed from the exterior of the test specimen. This is particularly needed on a miniature test specimen having a reduced exterior surface area for labeling.

The test specimen of this disclosure is a miniature test specimen, although the concepts of this disclosure can be applied to specimens of various sizes and the disclosure should not be interpreted as limited to only miniature test specimens. As an example, a typical miniature or subsize test specimen has a length of 100 mm, a gauge length of 25 mm and a gauge section width of 6 mm. The miniature test specimen of this disclosure has an exterior surface with an elongate length that extends between a first end surface and a second end surface at opposite ends of the test specimen. The test specimen exterior surface extends around the test specimen between the first end surface and the second end surface. The configuration of the test specimen can be the conventional “dumbbell” configuration. The configuration could also be cylindrical, for example a general cylindrical rod configuration that extends between the first end surface and the second end surface. The configuration of the test specimen could also be rectangular, for example a general rectangular strip configuration that extends between the first end surface and the second end surface.

A marking is provided on the exterior surface of the test specimen. The marking is integral with the test specimen and is integral with the exterior surface of the test specimen.

The marking identifies a property or properties of the test specimen and provides the test specimen with properties identification. For example, the marking could identify a material of a test specimen. The marking could identify a density of the test specimen and/or a grain structure of the test specimen. Where the material of the test specimen is an alloy, the marking can identify the alloy composition of the material of the test specimen. The marking can also identify a manufacturing process of the test specimen and/or a spatial location of the test specimen.

The exterior surface of the test specimen has a length between a first end area of the exterior surface adjacent the first end surface of the test specimen, and a second end area of the exterior surface adjacent the second end surface of the test specimen. The first end area of the exterior surface and the second end area of the exterior surface are configured for engagement with a holding device, for example a clamping device of a testing apparatus. In one example of the test specimen, the marking is on the first end area of the exterior surface. The exterior surface of the test specimen has a middle or center area of the exterior surface between the first end area of the exterior surface and the second end area of the exterior surface. The test specimen has a middle cross section dimension at the middle area or center area of the exterior surface. The test specimen also has end cross section dimensions at the first end area and the second end area of the exterior surface. The end cross section dimensions are larger than the middle cross section dimension.

On a test specimen of an object that has been produced by additive manufacturing or laser beam powder bed fusion, the marking on the exterior surface of the test specimen is produced by the laser beam as the laser beam is producing the test specimen attached to a side or edge of the product being produced by additive manufacturing.

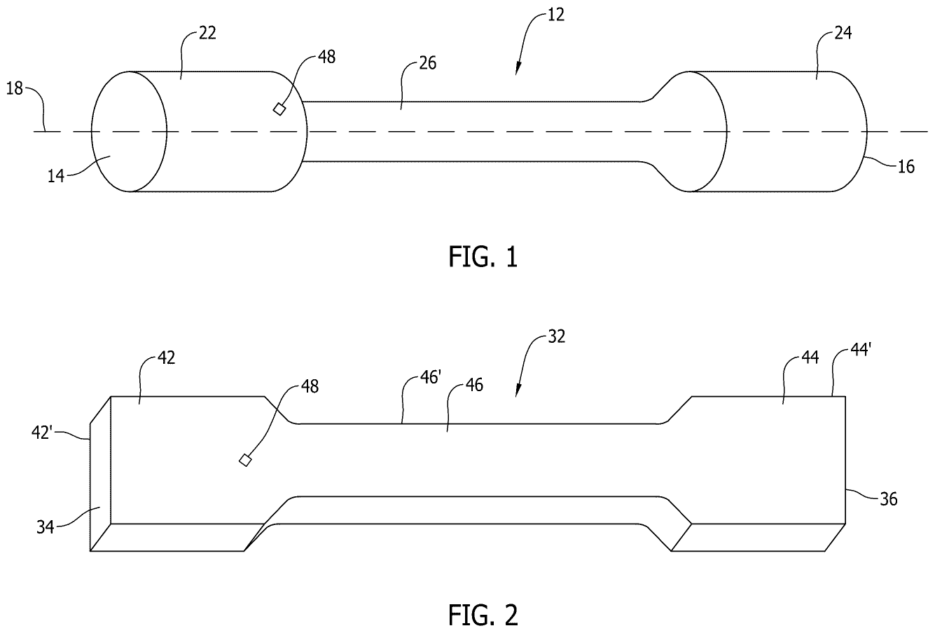

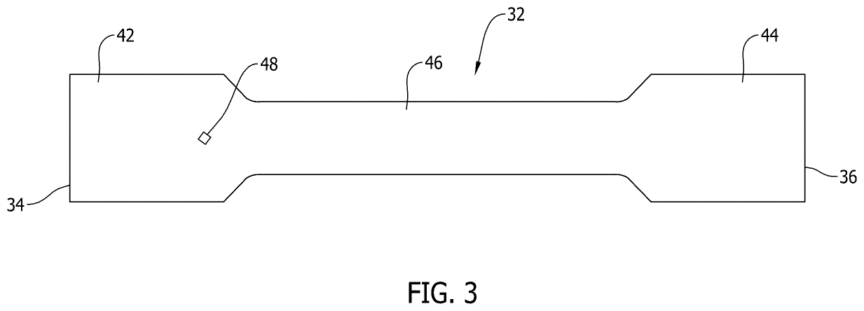

With reference to the figures, FIG. 1 illustrates a miniature test specimen 12 according to a first exemplary embodiment of this disclosure. Although the test specimen 12 of FIG. 1 is described as a miniature test specimen, the features of the test specimen 12 and the manner in which the test specimen 12 is produced can be applied to test specimens of various sizes. As represented in FIG. 1, the test specimen 12 has an exterior surface with an elongate length that extends between a first end surface 14 and a second end surface 16 at opposite ends of the test specimen 12. The test specimen 12 represented in FIG. 1 has the conventional “dumbbell” configuration. The first end surface 14 and the second end surface 16 are circular and are parallel surfaces. The first end surface 14 and second end surface 16 are coaxial and have a center axis 18 that extends through the centers of the end surfaces 14,16 and through the center of the length of the test specimen 12. The exterior surface of the test specimen 12 extends around the center axis 18 and extends along the length of the test specimen 12 between the first end surface 14 and the second end surface 16. With the example of the test specimen 12 represented in FIG. 1 having the conventional dumbbell configuration, the exterior surface has a first end area 22 of the exterior surface adjacent the first end surface 14 and a second end area 24 of the exterior surface adjacent the second end surface 16. The first end area 22 and the second end area 24 are cylindrical and are configured for engagement with a specimen holding device, for example a clamping device of a conventional testing apparatus. The first end area 22 of the exterior surface and the second end area 24 of the exterior surface have same cross section dimensions or same diameter dimensions. The first end area 22 is a first shoulder potion of the dumbbell configuration and the second end area 24 is a second shoulder portion of the dumbbell configuration.

The test specimen 12 also has a middle area 26 or center area of the exterior surface between the first end area 22 and the second end area 24 of the exterior surface. The middle or center area 26 of the exterior surface has a cross section dimension or a cross section diameter that is less than or smaller than the cross section dimension or diameter of the first end area 22 and the second end area 24 of the exterior surface. The middle or center area 26 of the exterior surface is the conventional testing area of the test specimen 12. The middle or center area 26 is the gauge portion of the dumbbell configuration. The gauge portion is at an intermediate location of the exterior surface of the test specimen 12 and the first shoulder portion and second shoulder portion are at opposite ends of the gauge portion.

The test specimen 12 can be constructed of various different types of materials desired to be tested. For example, the test specimen can be constructed of a metal, a metal alloy, or any other equivalent type of material that is desired to be tested.

FIG. 2 illustrates a miniature test specimen 32 according to a second exemplary embodiment of this disclosure. Although the test specimen 32 of FIG. 2 is described as a miniature test specimen, the features of the test specimen 32 and the manner in which the test specimen 32 is produced can be applied to test specimens of various different sizes. The second miniature specimen 32 has a “dumbbell” configuration similar to that of the first specimen 12, except that it is generally rectangular instead of cylindrical. As represented in FIG. 2, the first end surface 34 and the opposite second end surface 36 are rectangular and are parallel. The exterior surface of the test specimen 32 extends around the length of the test specimen 32 and extends along the length of the test specimen 32 between the first end surface 34 and the second end surface 36. The exterior surface has first end areas 42, 42′ on the opposite sides of the test specimen 32 and second end areas 44, 44′ on the opposite sides of the test specimen 32. The first end areas 42, 42′ and second end areas 44, 44′ are at opposite ends of the length of the exterior surface of the test specimen 32 and are flat, parallel surfaces. The surfaces of the first end areas 42, 42′ and the second end areas 44, 44′ are configured for engagement with specimen holding devices, for example clamping devices of a conventional testing apparatus.

With the test specimen 32 represented in FIG. 2 having the conventional “dumbbell” configuration, the exterior surface of the test specimen has a middle area or center area 46,46′ on opposite sides of the test specimen. The middle or center area 46,46′ of the exterior surface has a cross section dimension that is less than or smaller than the cross section dimension the first end areas 42,42′ and second end areas 44,44′ of the exterior surface. The middle or center area 46,46′ of the exterior surface is the conventional testing area of the test specimen 32.

As with the first described embodiment of the test specimen 12, the second test specimen 32 could also be constructed of various different types of materials desired to be tested.

A marking 48 is provided on the exterior surface of the test specimen 12 represented in FIG. 1 and on the exterior surface of the test specimen 32 represented in FIG. 2. The marking 48 is shown as being positioned on one of the end areas, the first end areas 22,42 of the respective specimens 12, 32. It should be understood that the marking 48 could also be located on the second end areas 24,44 of the respective specimens 12, 32. However, the marking 48 is not positioned on the middle or center areas 26,46 of the respective specimens 12, 32 to prevent the presence of the marking from interfering with the testing of the test specimens. Furthermore, the marking 48 is positioned on the first end areas 22,42 of the respective specimens 12, 32 away from the respective first end surfaces 14,34 of the test specimens. This is so that the marking 48 is not obscured when the first end surfaces 14,34 are engaged by the holding devices of a testing apparatus. Thus, the marking 48 is positioned toward the middle or center areas 26,46 of the respective specimens 12, 32 but is not positioned on the middle or center areas. This provides sufficient areas between the first end surfaces 14,34 of the respective specimens 12, 32 and the markings 48 that are configured to be held by the holding devices of the testing apparatus.

The marking 48 is represented as having the configuration of a diamond shape or square shape. However, this is only one example of a possible configuration of the marking 48. The marking 48 can be a single marking as represented in FIG. 1 and FIG. 2 or could be comprised of multiple markings. The marking 48 could be a number, a letter, a shape or any other representation that is visually discernible on the test specimens 12, 32. The marking 48 only needs to be discernible and recognizable as representing or identifying a property or properties of the test specimen 12, 32 and thereby provides the test specimen with properties identification. The marking 48 is integral with the test specimen 12, 32 and more specifically is integral with the exterior surface of the test specimen 12, 32. With the marking 48 being integral with the test specimen 12, 32, the marking cannot easily be removed from the test specimen or obscured on the test specimen. The marking 48 can immediately identify at least one property of the test specimen 12, 32 or can be used to identify a property or properties of the test specimen 12, 32 by first visually observing the marking 48, and then referring to a reference such as a manual, catalog, a data base or other equivalent type of information record that is separate from the test specimen 12, 32 and associates the marking 48 with properties of the test specimen set forth in the reference. The marking 48 can identify a material of a test specimen 12, 32, a density of the test specimen, a grain structure of the test specimen, and/or a composition of the test specimen.

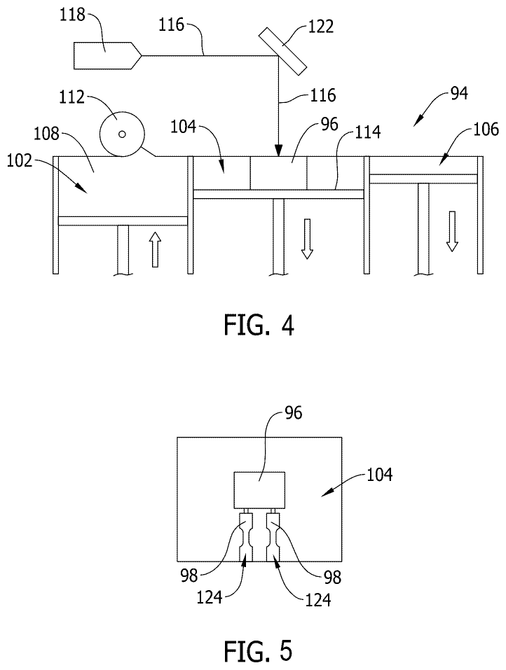

FIG. 4 is a schematic side elevation view of a test specimen being produced by additive manufacturing, for example by a laser powder bed fusion machine 94.

FIG. 5 is a schematic plan view of the product 96 and attached test specimens 98 produced by the laser powder bed fusion machine 94.

The laser powder bed fusion machine 94 has a conventional construction and comprises a powder supply cell 102, a powder build cell 104 and a powder collection cell 106. The powder supply cell 102 contains the supply of metal powder 108 that is moved by a layer roller 112 from the powder supply cell 102 to the powder build cell 104. The object or product 96 being produced by the laser powder bed fusion machine 94 is supported on a build platform 114 in the powder build cell 104. The object 96 is built up, layer by layer in a conventional manner by layers of metal powder 108 supplied from the powder supply cell 102 to the powder build cell 104 and the object 96 by the layer roller 112. Excess powder supplied by the layer roller 112 to the powder build cell 104 and the object 96 is pushed by the roller 112 from the powder build cell 104 to the powder collection cell 106.

A laser beam 116 produced by a laser 118 is reflected off a mirror 122 and is directed to the top of the object 96 being produced. Although the laser 118 is described as the source of power used to produce the object 96 and the test specimens 98, it should be understood that another type of a source of power could be used. For example, an electron beam gun emitting an electron beam or another equivalent type of source of power could be used to produce the object 96 and the test specimens 98 instead of the laser 118. The laser beam 116 fuses the layer of powder that has been pushed by the roller 112 over the object 96 to the top of the object 96. As the object 96 is produced by the laser powder bed fusion machine 94, the object 96 is formed layer by layer by the roller 112 spreading a layer of powder material 108 from the powder supply cell 102 over the powder build cell 104 and over the object 96 supported on the build platform 114. Each successive layer of powder 108 spread over the top of the object 96 is fused to the top of the object by the laser beam 116 in a conventional manner. As layers of powder are fused by the laser 118 to the top of the object 96, the laser 118 is controlled to also fuse the layer of powder supplied by the roller 112 to form a tab or tabs 98 attached to the side of or an edge of the object 96 being formed. The tabs 98 attached to the side of the object 96 are represented in the plan view in FIG. 8. Each of the tabs 98 is formed as a specimen 98 of the material of the object 96 being produced by the laser powder bed fusion machine 94. As the object 96 is being produced, the tabs or test specimens 98 of the object 96 are produced. The test specimens 98 are produced when a layer of the powder 108 is spread by the layer roller 112 from the powder supply cell 102 over the powder build cell 104 and over a previously formed layer of powder fused to the top of the object 96. After a new layer of powder is delivered by the roller 112 over the powder build cell 104 and over the object 96 supported on the build platform 114, the laser 118 is controlled and operated to delineate the tabs of the test specimens 98 extending from the edge or side of the object 96 being formed as the laser fuses the powder of the just spread layer of powder to the top of the object 96. This forms the tabs or specimens 98 extending from an edge or side of the object 96 being formed by the laser powder bed fusion machine 94 while producing the layer of the object 96 and while producing the object 96.

As the test specimens 98 are formed by laser fusion of a layer of powder supplied to the powder build cell 104 and to the top of the object 96, the laser 118 is further controlled to produce markings 124 integral with the test specimens 98 on the exterior surfaces of the test specimens 98 being formed. The markings 124 can be formed as barcode type identifications or as various types of markings 124 such as those described earlier. The markings 124 identify properties of the object 98 being produced such as the properties described earlier. Thus, the test specimens 98 and the markings 124 on the test specimens 98 are produced as the object or product 96 is produced

In view of the above, it will be seen that the several objects and advantages of the present invention have been achieved and other advantageous results have been obtained.

Example embodiments are provided so that this disclosure will be thorough, and will fully convey the scope to those who are skilled in the art. Numerous specific details are set forth such as examples of specific components, electronic devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known electronic device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the electronic device in use or operation in addition to the orientation depicted in the figures. For example, if the electronic device in the figures is turned over, elements described as “below” or “beneath” other elements or features would then be oriented “above” the other elements or features. Thus, the example term “below” can encompass both an orientation of above and below. The electronic device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. A test specimen comprising:
an exterior surface on the test specimen;
a marking on the exterior surface of the test specimen, the marking integral with the exterior surface of the test specimen; and
the marking identifying at least one property of the test specimen.

2. The test specimen of claim 1, wherein the marking identifies a material of the test specimen.

3. The test specimen of claim 1, wherein the marking identifies a density of the test specimen.

4. The test specimen of claim 1, wherein the marking identifies a composition of the test specimen.

5. The test specimen of claim 1, wherein the marking identifies a manufacturing process of the test specimen and/or a spatial location of the test specimen.

6. The test specimen of claim 1, wherein:
the exterior surface has a first end area, a second end area, and a length defined between the first end area and the second end area;
the exterior surface further includes a middle area between the first end area and the second end area;
the marking is on the first end area of the exterior surface.

7. The test specimen of claim 6, wherein:
the test specimen has a middle cross section dimension at the middle area of the exterior surface;
the test specimen has a first end area cross section dimension at the first end area and a second end area cross section dimension at the second end area;
the first end area cross section dimension of the first end area is larger than the middle cross section dimension of the middle area of the exterior surface; and
the second end area cross section dimension of the second end area is larger than the middle cross section dimension of the middle area of the exterior surface.

8. The test specimen of claim 6, wherein the first end area of the exterior surface and the second end area of the exterior surface are configured for engagement with a holding device of a testing apparatus.

9. The test specimen of claim 1, wherein:
the test specimen comprises a test specimen produced by laser powder bed fusion as a tab that is integral with and extends from an object produced by laser powder bed fusion; and
the marking on the exterior surface of the test specimen comprises a marking produced by laser powder bed fusion integral with the exterior surface of the test specimen as the object was produced by laser powder bed fusion.

10. The test specimen of claim 1, wherein:
the test specimen comprises a test specimen produced by additive manufacturing; and
the marking on the exterior surface of the test specimen comprises a marking produced by additive manufacturing on the exterior surface of the test specimen when the test specimen was produced by additive manufacturing.

11. A test specimen comprising:
an exterior surface of the test specimen;
the exterior surface of the test specimen having a gauge portion at an intermediate location of the exterior surface of the test specimen;
the exterior surface of the test specimen having a first shoulder portion and a second shoulder portion at opposite ends of the gauge portion; and
a marking on the first shoulder portion, the marking integral with the first shoulder portion, and the marking identifying at least one property of the test specimen.

12. The test specimen of claim 11, wherein the marking identifies a material of the test specimen.

13. The test specimen of claim 11, wherein the marking identifies a density of the test specimen.

14. The test specimen of claim 11, wherein the marking identifies a grain orientation of the test specimen.

15. The test specimen of claim 11, wherein the marking identifies a manufacturing process of the test specimen and/or a spatial location of the test specimen.

16. The test specimen of claim 11, wherein:
the test specimen has a gauge cross section dimension at the gauge portion of the exterior surface;
the test specimen has a first shoulder cross section dimension at the first shoulder portion and a second shoulder cross section dimension at the second shoulder portion; and
the gauge cross section dimension is smaller than each of the first and second shoulder cross section dimensions.

17. The test specimen of claim 11, wherein the first shoulder portion and the second shoulder portion are configured for engagement with a holding device of a testing apparatus.

18. The test specimen of claim 11, wherein:
the test specimen comprises a test specimen produced by additive manufacturing; and
the marking on the first shoulder portion comprises a marking produced by additive manufacturing on the first shoulder portion when the test specimen was produced by additive manufacturing.

19. The test specimen of claim 11, wherein:
the test specimen comprises a test specimen produced by laser powder bed fusion as a tab that is integral with and extends from an object produced by laser powder bed fusion; and
the marking on the exterior surface of the test specimen comprises a marking produced by laser powder bed fusion integral with the exterior surface of the test specimen as the object was produced by laser powder bed fusion.

20. A method of producing a test specimen with properties identification comprising:
producing the test specimen with an exterior surface; and
marking the exterior surface with an integral marking on the exterior surface when producing the test specimen, the integral marking identifying at least one property of the test specimen by the integral marking.

21. The method of claim 20, wherein the method includes producing the test specimen by laser powder bed fusion.

22. The method of claim 20, wherein the method includes producing the test specimen by additive manufacturing.

23. The method of claim 20, wherein:
producing the test specimen with the exterior surface comprises producing the test specimen with the exterior surface by additive manufacturing; and
marking the exterior surface with the integral marking on the exterior surface comprises producing the integral marking produced by additive manufacturing as the test specimen is produced by additive manufacturing.

24. The method of claim 20, wherein:
producing the test specimen with the exterior surface comprises producing the test specimen with the exterior surface by laser powder bed fusion as a tab that is integral with and extends from an object produced by laser powder bed fusion; and
marking the exterior surface with the integral marking on the exterior surface comprises producing the integral marking by laser powder bed fusion integral with the exterior surface of the test specimen as the object is produced by laser powder bed fusion.
